(19) United States
(12) Patent Application Publication
(10) Pub. No.: US 2025/0067104 A1
(43) Pub. Date: Feb. 27, 2025

(54) BARRIER-FREE SLIDING DOOR WITH A TRANSVERSELY MOVABLE LEAF

(71) Applicant: Roto Frank Fenster- und Tuertechnologie GmbH, Leinfelden-Echterdingen (DE)

(72) Inventors: Michael Metzger, Waldenbuch (DE); Choongeun Park, Stuttgart (DE); Zsolt Varsanyi, Sopron (HU)

(73) Assignee: Roto Frank Fenster- und Tuertechnologie GmbH, Leinfelden-Echterdingen (DE)

(21) Appl. No.: 18/941,466

(22) Filed: Nov. 8, 2024

Related U.S. Application Data
(63) Continuation of application No. PCT/EP2023/061589, filed on May 3, 2023.

(30) Foreign Application Priority Data
May 17, 2022 (DE) 10 2022 204 890.3

(51) Int. Cl. E05D 15/10

(52) U.S. Cl. CPC E05D 15/10; E05D 2015/1026; E05D 2015/1039; E05Y 2201/684; E05Y 2600/456; E05Y 2900/132

(57) ABSTRACT

A door including a barrier-free sill is disclosed. The sill preferably has recesses on its upper side, the width of the recesses being less than 50 mm and/or the depth of the recesses being less than 3 mm. A leaf can penetrate the upper side in a leaf recess. The leaf may fall below the vertically uppermost dimension of a running rail. Using at least one projection of a carriage that extends into a guide groove, it is possible to reliably seal or transversely support the leaf in the event of wind pressure or a break-in attempt. The projection preferably extends further down than a running roller of the carriage. This enables the design of a particularly stable and yet barrier-free door.

### CROSS-REFERENCE TO RELATED APPLICATIONS

This continuation application claims priority to PCT/EP2023/061589 filed on May 3, 2023, which has published as WO 2023/222379 A1 and also the German application number DE 10 2022 204 890.3 filed on May 17, 2022, the entire contents of which are fully incorporated herein with these references.

### DESCRIPTION

### FIELD OF THE INVENTION

The invention relates to a door (door, sliding door or French door) according to the preamble of claim 1 with a running rail comprising a sill, a leaf that can be displaced in parallel with the running rail, and a carriage via which the leaf is supported on the underside of the running rail. The carriage comprises a roller part with at least one running roller and a control cam running at least in sections at an angle to the main plane of the leaf. The roller part is designed to be movable transversely to the main plane of the leaf. The leaf comprises a driving bar with a control pin which is arranged or formed on the driving bar and protrudes into the control cam so that a movement of the driving bar in the direction of its longitudinal axis causes a movement of the leaf transverse to the running rail.

### BACKGROUND OF THE INVENTION

EP 2 829 679 B1 describes a door of this type that allows heavy leaf loads to be transferred. However, in order to seal the known door, it is necessary to provide stops for the leaf in the region of the sill. Therefore, the known door is insufficiently barrier-free.

In order to make apartments suitable for the elderly, it is desirable to design sliding doors to be as low-barrier as possible.

DE 10 2016 105 941 A1 describes the use of a largely flat sill with drainage openings.

DE 10 2017 130 894 A1, DE 10 2017 130 912 A1, DE 10 2019 135 411 A1, DE 10 2020 102 901 A1, DE 20 2017 001 325 U1, EP 3 502 399 B1, EP 3 596 295 B1 and NL 2004524 C disclose low-barrier lift-and-slide doors.

DE 10 2019 211 790 A1 and DE 10 2019 211 794 A1 disclose fittings for low-barrier sliding doors with transversely movable leaves (transverse to the extension of a running rail of the doors).

The problem with the known low-barrier sliding doors is that the leaves become heavier and heavier due to their multiple glazing and increasing size so that the transverse adjustment/movement of the leaves is only possible in a structurally complex manner.

### SUMMARY OF THE INVENTION

### Object of the Invention

It is therefore the object of the invention to provide a displaceable door that is simple in design, can transfer heavy leaf loads, can be reliably sealed and yet is barrier-free.

### Description of the Invention

This object is achieved according to the invention by a door according to claim 1. The dependent claims reflect preferred developments.

The object according to the invention is thus achieved by a door described at the beginning, in which the sill comprises recesses on the upper side whose respective maximum horizontal width (perpendicular to the extension of the running rail) does not exceed 50 mm, in particular, 45 mm, preferably 40 mm, and/or whose respective maximum vertical depth does not exceed 3 mm, in particular 2 mm.

The door according to the invention makes barrier-free crossing of the sill possible, even with heavy leaves.

The location designations “top,” “bottom,” “above,” “below,” “to the side,” “transverse,” and the like refer to the assembled state of the door.

The roller part can be made up of multiple parts and comprise, for example, a suspension and/or vertical height adjustment.

In particular, the running rail can be designed in the form of an upward-facing rail or a running groove.

Particularly preferably, the leaf extends on the underside into a leaf recess of the sill. As a result, the door can be sealed particularly well.

The upper side is understood to be the upper tensioned envelope of the sill. Therefore, the upper side of the sill defines an imaginary enveloping surface. If a thick or firm cloth were placed on the sill, it would come to rest on the upper side of the sill.

A door, wherein the door comprises the following: a) a sill with a running rail; b) a leaf that can be displaced in parallel with the running rail and is supported downward by a carriage of the door on the running rail;

wherein the carriage comprises a roller part with a running roller rolling on the running rail and a control cam running at least in sections at an angle to the main plane of the leaf, wherein the roller part is designed to be movable transversely to the main plane of the leaf; and the leaf comprises a driving bar with a control pin which is arranged or formed on the driving bar and protrudes into the control cam so that a movement of the driving bar in its longitudinal direction causes a movement of the roller part transverse to the main plane of the leaf, in order to move the leaf transversely to the running rail; wherein the leaf at its underside dips in sections into a leaf recess of the sill so that the leaf extends in sections below the upper side of the sill, represents an independent aspect of the invention. The above combination of features can be combined with all other features described here.

Particularly preferably, the upper side of the sill perpendicular to the running rail does not form an angle greater than 25°, in particular, greater than 20°, preferably greater than 15°, to the horizontal at any point. This makes the sill particularly easy to roll over.

The leaf recess or the leaf can comprise a sealing strip which extends in parallel with the running rail and, in its closed position, seals the leaf toward the sill.

On its underside, the leaf can extend to below the uppermost point of the running rail. As a result, the door can be sealed particularly well despite its freedom from barriers.

A door, wherein the door comprises the following: a) a sill with a running rail; b) a leaf that can be displaced in parallel with the running rail and is supported downward by a carriage of the door on the running rail;

wherein the carriage comprises a roller part with a running roller rolling on the running rail and a control cam running at least in sections at an angle to the main plane of the leaf, wherein the roller part is designed to be movable transversely to the main plane of the leaf; and the leaf comprises a driving bar with a control pin which is arranged or formed on the driving bar and protrudes into the control cam, so that a movement of the driving bar in its longitudinal direction causes a movement of the roller part transverse to the main plane of the leaf, in order to move the leaf transversely to the running rail; wherein the leaf at its underside extends in sections below the uppermost point of the running rail, represents an independent aspect of the invention. The above combination of features can be combined with all other features described here.

The running rail can be formed on a rail that can be locked, clipped and/or pressed into place, in particular, vertically, on at least one other part of the sill. In a further preferred embodiment of the invention, the running rail is formed on a pivotable rail. The rail is preferably pivotable about the longitudinal axis of the running rail or about an axis extending in parallel with the longitudinal axis of the running rail. Particularly preferably, in its assembled end position, the rail is locked in place to at least one other part of the sill. This makes the running rail particularly easy to assemble.

The running rail can be arranged or formed on an attachment part of the sill. The attachment part makes retrofitting of a non-barrier-free door into a barrier-free door possible.

The running rail is particularly preferably formed on a rail that can be locked, clipped and/or pressed in place with the attachment part. In particular, the rail can be pivoted into the attachment part and locked in place.

On the underside, the leaf can comprise an extension part extending down. The extension part can be subsequently assembled to the leaf in order to create a leaf that extends further down.

In a further preferred embodiment of the invention, the upper-side recesses of the sill are delimited by jump lines which extend in parallel with the running rail and in particular lie in a (virtual) plane. Whenever the upper side is interrupted by a recess, two jump lines are created at the two upper corners of this recess. When driving over a recess with a rollator or wheelchair, the wheel of the rollator or wheelchair should jump from one jump line to the opposite jump line.

In a particularly preferred embodiment of the invention, the vertical height difference of all neighboring jump lines between which there is a recess is less than 3 mm, in particular, less than 2 mm, particularly preferably less than 1 mm, and the width of the recesses is less than 50 mm, in particular less than 45 mm, preferably less than 40 mm.

This embodiment makes it possible to roll over the sill with particularly low resistance.

Loads transverse to the main plane of the leaf can be transferred particularly safely via the carriage if the carriage comprises a fastening part arranged on the leaf and comprising a guide cam through which the control pin protrudes. The roller part can be arranged on the fastening part so that it can move transversely to the main plane of the leaf. Preferably, the roller part is guided on the fastening part via a dovetail guide.

The sill can comprise a first guide groove extending in parallel with the running rail, in particular directly next to the running rail, wherein a first projection of the carriage extends down beyond the at least one running roller into the first guide groove so that the carriage can be supported via the first projection on the side wall of the first guide groove or the side of the running rail when the leaf is loaded transversely to the main plane of the leaf. This makes possible the reliable introduction of forces that act transversely to the main plane of the leaf, for example due to wind or an attempted break-in, wherein the freedom from barriers of the doors is nevertheless ensured. Alternatively or additionally, the first projection can extend down beyond the upper side.

The first projection can comprise a bearing that can roll on the side wall of the first guide groove or the side of the running rail when the leaf is loaded transversely to the main plane of the leaf. This ensures low-friction and low-noise displacement of the door parallel to the extension of the running rail, even in the event of heavy loads on the leaf transverse to its main plane or in the event of structural deviations in the region of the sill.

The bearing can be made up of multiple parts. The bearing can comprise a bushing and a shell. The bushing preferably has a low friction coefficient, for example due to its PTFE design.

The roller part can comprise a rivet bolt for fastening the bearing. Alternatively or additionally, the first projection can comprise a cap to hold the bearing.

The roller part can comprise an attachment with the first projection, which is fastened to a roller part body. The attachment is preferably fastened to the roller part body in a twist-proof manner. The attachment may be riveted to the roller part body.

Preferably, the roller part body comprises a fastening pin extending down for receiving a transverse roller to which the attachment is fastened. As a result, the attachment can be easily retrofitted.

The roller part can furthermore comprise a second projection, which extends down beyond the at least one running roller into the first guide groove in order to support the leaf via the second projection on the side wall of the first guide groove or the side of the running rail when the leaf is loaded transversely to the main plane of the leaf. Alternatively or additionally, the second projection can extend down beyond the upper side.

The second projection is particularly preferably arranged or formed on the attachment. The second projection ensures the transfer of higher forces. This allows forces to be transferred to the sill transversely to the main plane of the leaf without generating a torque on the attachment.

The first projection and the second projection can be formed identically.

In addition to the first guide groove, the sill can comprise a second guide groove extending in parallel with the running rail, in particular directly next to the running rail, wherein the running rail is located between the two guide grooves, and wherein a further projection extends down beyond the at least one running roller, in particular the upper side, into the second guide groove in order to support the carriage via the further projection on the side wall of the second guide groove or the side of the running rail when the leaf is loaded transversely to the main plane of the leaf.

The second guide groove can be formed mirror-symmetrically to a virtual plane extending vertically and in the longitudinal direction of the running rail in the middle of the running rail.

The first guide groove and the second guide groove can be formed identically.

The design of the door is further simplified if the attachment is designed to be mirror-symmetrical to a (virtual) plane extending vertically and centrally in the longitudinal direction of the running rail.

The upper-side recesses have a horizontal width perpendicular to the running rail of more than 0 mm, in particular, more than 1 mm, preferably more than 5 mm. The vertical depth of the upper-side recesses is greater than 0 mm, in particular, greater than 1 mm, preferably greater than 2 mm.

Further advantages of the invention can be found in the description and the drawings. Likewise, according to the invention, the aforementioned features and those which are to be explained below can each be used individually or together in any desired combinations. The embodiments shown and described are not to be understood as an exhaustive list, but, rather, have an exemplary character for the description of the invention.

### BRIEF DESCRIPTION OF THE DRAWINGS

FIG. 1a shows a schematic sectional view of a first exemplary embodiment of a door with a sill, a leaf and a carriage, wherein the door is in the unlocked state.

FIG. 1b shows the door of FIG. 1a in the locked state.

FIG. 2a shows a schematic sectional view of a further exemplary embodiment of a door in the unlocked state, wherein one leaf of the door comprises an extension part extending down.

FIG. 2b shows the door of FIG. 2a in the locked state.

FIG. 3a shows a schematic sectional view of a further exemplary embodiment of a door in the unlocked state, in which the leaf, in contrast to the embodiments shown in FIGS. 1a to 2b, does not extend below a running rail of the door.

FIG. 3b shows the door of FIG. 3a in the locked state.

FIG. 4a shows an isometric view of a driving bar with a control pin for controlling a carriage.

FIG. 4b shows an isometric view of a carriage in the locked state.

FIG. 4c shows a top view of the carriage of FIG. 4b in the unlocked state, wherein the control pin of FIG. 4a is indicated by a dashed line.

FIG. 4d shows the carriage of FIG. 4c in the locked state.

FIG. 5a shows a partially exploded view of a carriage with two projections, each comprising a bearing.

FIG. 5b shows an isometric view of the carriage of FIG. 5a in the assembled state.

FIG. 6a shows a partially exploded view of a carriage with two projections, each comprising a bearing, wherein the bearings differ from the bearings shown in FIG. 5a.

FIG. 6b shows an isometric view of the carriage of FIG. 6a in the assembled state.

FIG. 7a shows a partially exploded view of a carriage with projections designed to be symmetrical to a running rail.

FIG. 7b shows an isometric view of the carriage of FIG. 7a in the assembled state.

### DETAILED DESCRIPTION OF EMBODIMENTS OF THE INVENTION

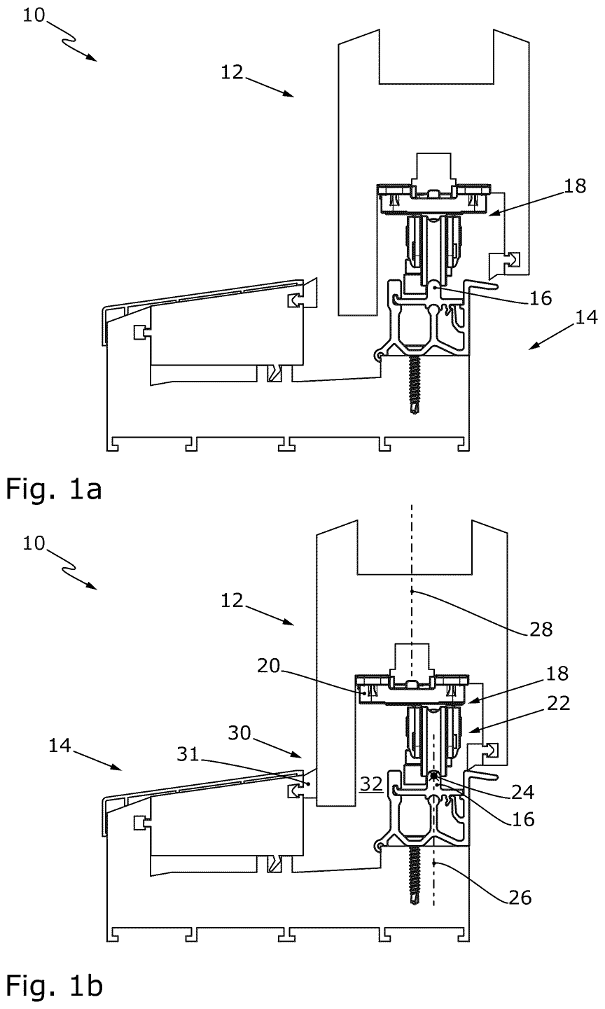

FIG. 1a shows a door 10 with a leaf 12 and a sill 14. The sill 14 comprises a running rail 16, which in the present case extends into or out of the paper plane. The leaf 12 is supported by a carriage 18 on the running rail 16. FIG. 1a shows the leaf 12 in the unlocked state.

FIG. 1b shows the door 10 according to FIG. 1a in the locked state. From FIG. 1b, it can be seen that the carriage 18 comprises a fastening part 20, which is arranged immovably on the leaf 12. The carriage 18 also comprises a roller part 22, which can be moved horizontally and transversely, here perpendicularly, to the fastening part 20. The fastening part 20 can be moved transversely to the direction of extension 24 (shown in FIG. 1b by a cross with a circle) of the running rail 16. More precisely, the fastening part 20 can be forcibly moved transversely, here perpendicularly, to a virtual plane 26 extending vertically and in the longitudinal direction of the running rail 16 in the middle of the running rail 16. The movement of the leaf 12 transverse, here perpendicular, to its main plane 28 of the leaf (the main plane here running in parallel with the center plane 26) causes the leaf 12 to be transferred from the unlocked state shown in FIG. 1a to the locked state shown in FIG. 1b.

From FIG. 1b, it can also be seen that, in the locked state, the leaf 12 is sealed toward the sill 14 by a seal 30. The seal 30 extends in parallel with the center plane 26. The seal 30 comprises a sealing strip 31, which is arranged on the leaf 12 or, as in the present case, on the sill 14.

In order to achieve a good seal and nevertheless achieve a barrier-free design of the door 10, the leaf 12 at its lower end protrudes into the sill 14, more precisely into a leaf recess 32 of the sill 14. In the present case, the leaf 12 at its lower end protrudes below the upper side of the running rail 16, i.e., the leaf 12 with its underside extends below the uppermost surface portion of the running rail 16.

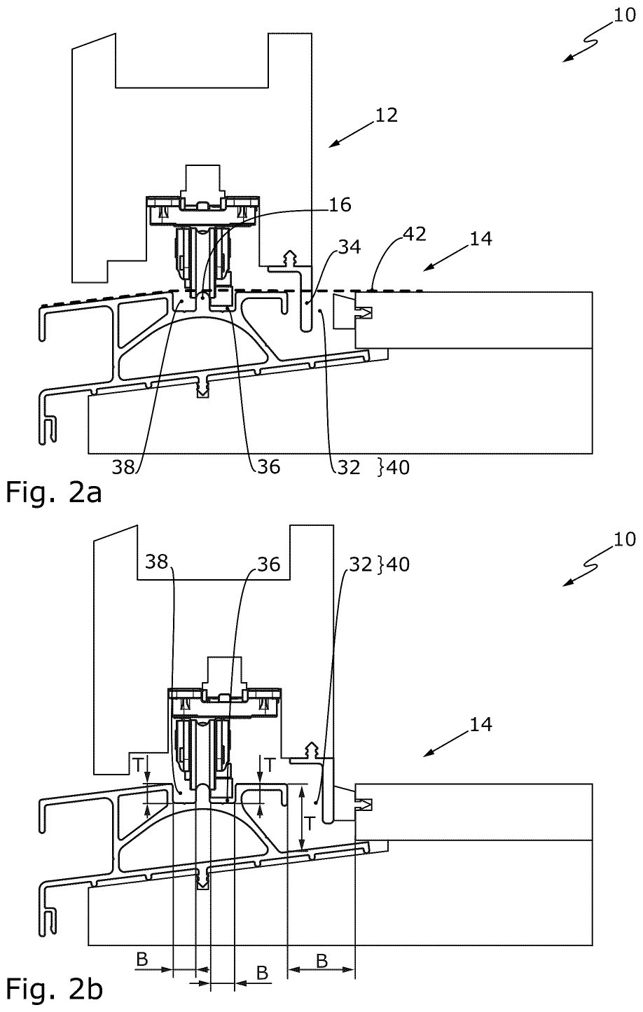

FIG. 2a shows an alternative embodiment of a door 10 with a leaf 12, which comprises an extension part 34 at its lower end. The extension part 34 protrudes into the leaf recess 32 of the sill 14.

In addition to the leaf recess 32, the sill 14 comprises a first guide groove 36 and a second guide groove 38 on the upper side. A running rail 16 is located directly next to the guide grooves 36, 38. The leaf recess 32 and the guide grooves 36, 38 represent, generally speaking, recesses 40 of the sill 14. The sill 14 can comprise further recesses 40 on its upper side 42. The upper side 42 is to be understood as the enveloping surface spanning the sill 14 (in the sectional side view of FIG. 2a, the enveloping curve of the upper side 42 is indicated by a dashed line). “Soft components,” such as the sealing strip 31, are preferably not taken into account when considering the upper side 42.

FIG. 2b shows the door 10 of FIG. 2a in the locked state. It can be seen from FIG. 2b that the respective maximum width B of the recesses 40 does not exceed a dimension of 50 mm. Alternatively or additionally, the respective maximum depth T of the recesses 40 does not exceed a dimension of 3 mm. This makes the sill 14 particularly easy to drive over.

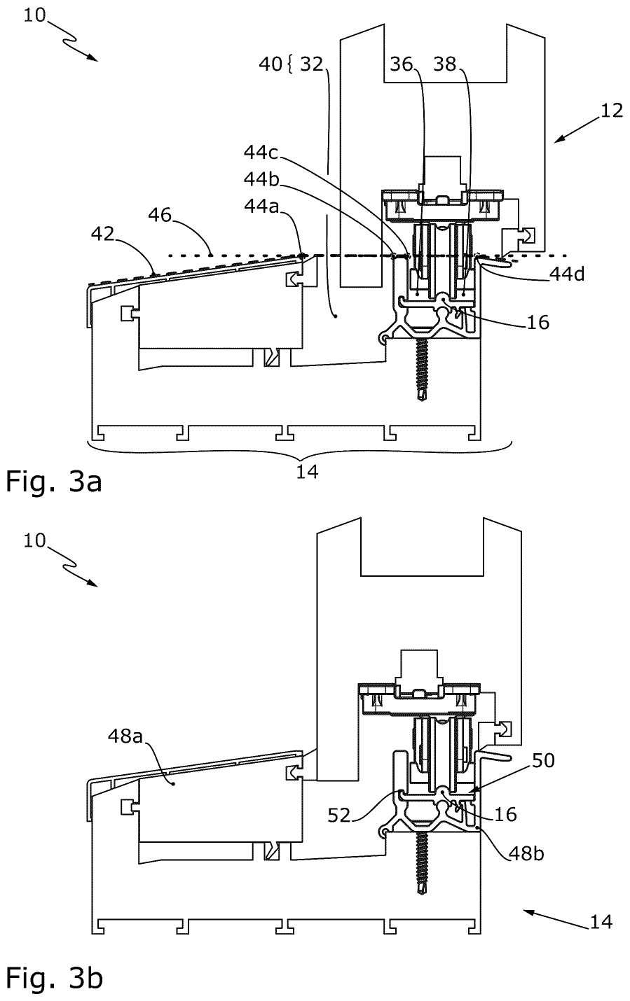

FIG. 3a shows a further embodiment of a door 10 with a leaf 12 and a sill 14, wherein the leaf 12 protrudes at its lower end through the upper side 42 of the sill 14 but ends above the running rail 16.

The upper side 42 comprises jump lines 44a, 44b, 44c, 44d, which extend in parallel with the running rail 16 and are indicated in the sectional side view of FIG. 3a in the form of jump points. The jump lines 44a-d delimit the horizontal width B (cf. FIG. 2b) of the recesses 40. The jump lines 44a-d preferably lie on a virtual plane 46 so that the sill 14 is particularly easy to roll over. The vertical height difference of all neighboring jump lines 44a-d, between which a recess 40 is located in each case, is preferably less than 3 mm, in particular less than 2 mm.

FIG. 3b shows the door 10 of FIG. 3a in the locked state. It can be seen from FIG. 3b that the sill 14 comprises at least one attachment part 48a, 48b, here two attachment parts 48a, b. The attachment part(s) 48a, b make it possible for a door to be subsequently converted into a barrier-free door 10. It is understood that the sill 14 can also be designed as a single piece.

In the present case, the running rail 16 is formed on a rail 50, i.e., a rail-shaped, here plate-shaped, component. The rail 50 is pivotable about an axis 52 in order to be able to be easily assembled on the attachment part 48b. The axis 52 extends in parallel with the longitudinal axis of the running rail 16. In the pivoted-in state, the rail 50 locks into place on the attachment part 48b. In an alternative embodiment, the rail 50 can be formed in one piece with the attachment part 48b. In other words, the attachment part 48b can itself contain the running rail 16.

Preferred embodiments of carriages 18 for barrier-free doors 10 are described below.

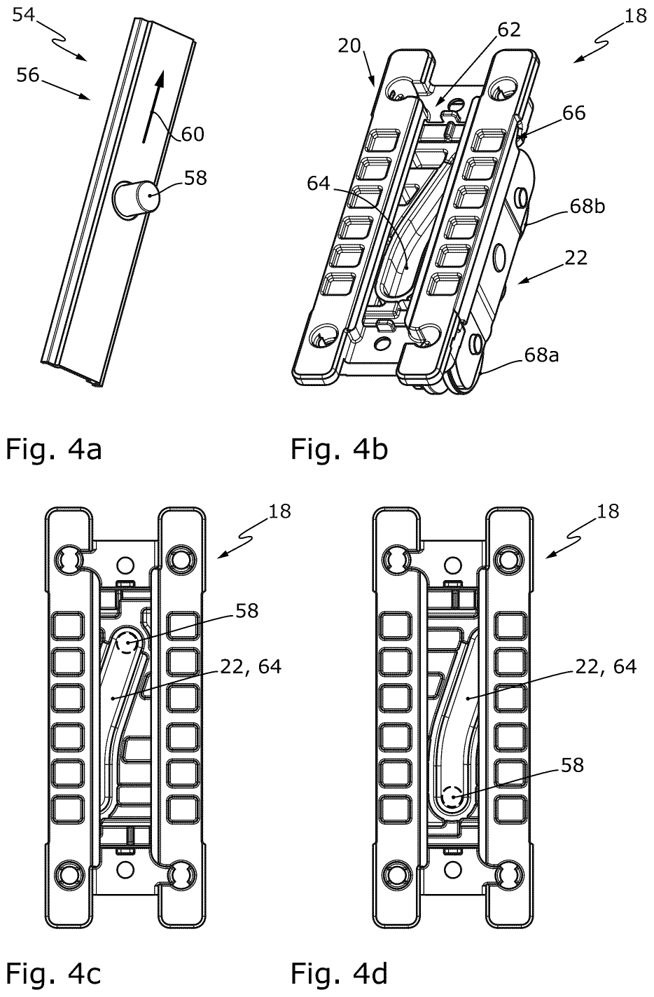

FIG. 4a shows a driving bar unit 54 with a driving bar 56 and a control pin 58. The control pin 58 is rotatably or non-rotatably arranged or formed on the driving bar 56. The driving bar 56 is arranged on the leaf 12 so as to be displaceable in the direction of its longitudinal axis 60 (see, for example, FIG. 1a).

FIG. 4b shows a carriage 18 with a fastening part 20 that can be assembled on the leaf 12 (see FIG. 1a). The fastening part 20 comprises a guide cam 62. The control pin 58 (see FIG. 4a) protrudes through the guide cam 62 and protrudes into a control cam 64 of a roller part 22. The roller part 22 can be moved by a guide 66, here in the form of a dovetail guide, transversely, here perpendicularly, to the longitudinal axis 60 (see FIG. 4a) of the driving bar 56, or to the longitudinal extension of the guide cam 62, relative to the fastening part 20.

The roller part 22 comprises at least one running roller 68a, 68b, here exactly two running rollers 68a, b.

The movement of the roller part 22 is effected by a force-guided movement of the driving bar 56 (see FIG. 4a) in the direction of its longitudinal axis 60. This is illustrated below using FIGS. 4c and 4d.

FIG. 4c and FIG. 4d show the carriage 18 in a top view with the control pin 58 (indicated by a dashed line) (cf. FIG. 4a). From FIGS. 4c and 4d, it can be seen that the control cam 64 is formed at least in sections at an angle to the longitudinal axis 60 (see FIG. 4a) so that a movement of the control pin 58 causes a transverse movement of the roller part 22.

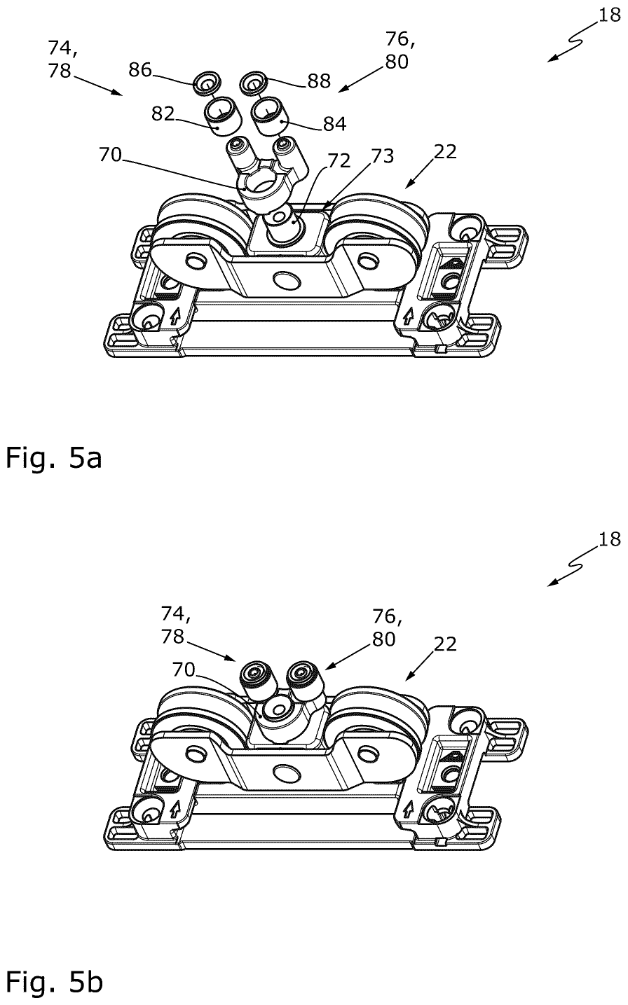

FIG. 5a and FIG. 5b show a variant of the carriage 18 with an attachment 70. The attachment 70 is arranged on a fastening pin 72, extending in particular, vertically, of a roller part 22. The fastening pin 72 is part of a roller part body 73. The attachment 70 is preferably riveted in place.

The attachment 70 comprises a first projection 74 and a second projection 76. The projections 74, 76 can, as in the present case, be formed identically. The projections 74, 76 are arranged on the same side of the carriage 18 when viewed perpendicularly to the direction of the running rail 16 (see FIG. 2a). Therefore, they protrude into the same guide groove 36, 38. Due to the arrangement on the same side of the carriage 18, the attachment 70 is arranged on the fastening pin 72 in a particularly twist-proof manner.

In order to make a particularly quiet movement of the carriage 18 possible even if the door 10 has structural tolerances (see FIG. 1a), the projections 74, 76 can comprise bearings 78, 80. The bearings 78, 80 can in each case comprise a shell 82, 84 and/or a cap 86, 88.

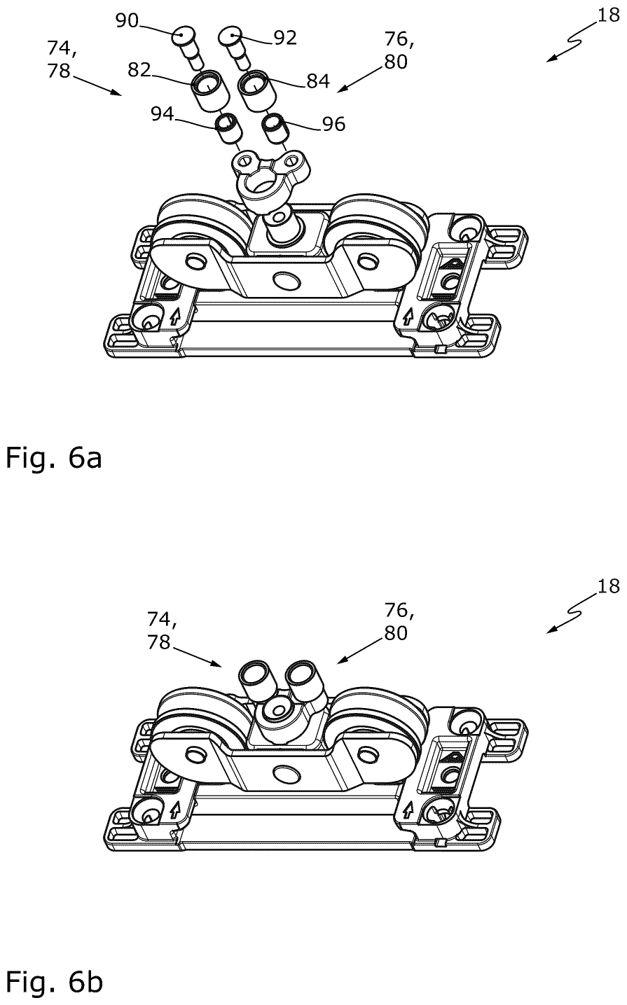

FIG. 6a and FIG. 6b show a variant of a carriage 18 in which projections 74, 76 comprise bearings 78, 80, wherein the bearings 78, 80 are in each case fastened by a rivet 90, 92. The bearings 78, 80 in each case comprise a shell 82, 84 and a bushing 94, 96. The bushings 94, 96 can be made of a low-friction material, for example PTFE (polytetrafluoroethylene). The bushings 94, 96 can also be formed in each case in one piece with the shells 82, 84.

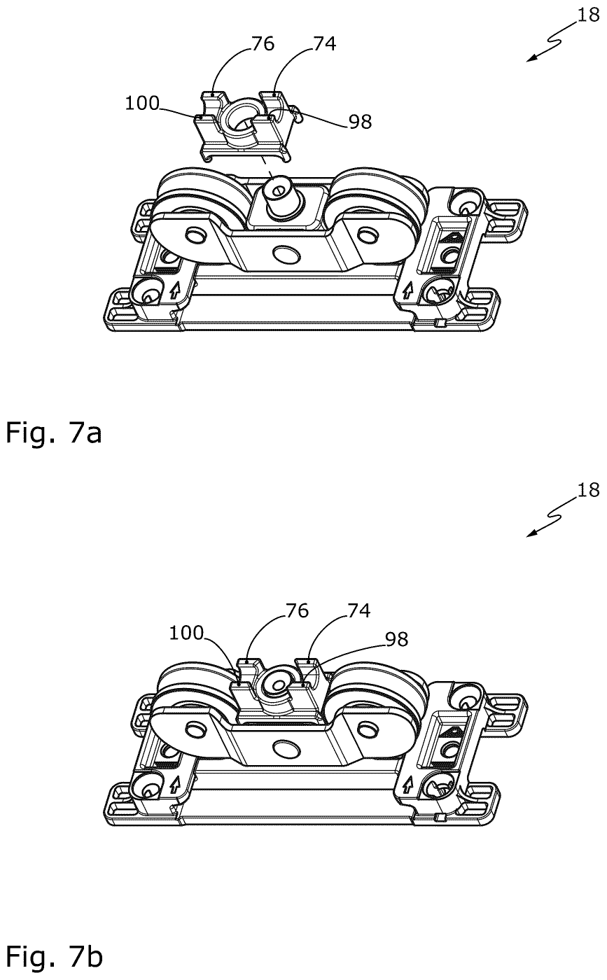

FIG. 7a and FIG. 7b show a further variant of a carriage 18 with a first projection 74, a second projection 76 and further projections 98, 100. The projections 74, 76, 98, 100 are designed to be symmetrical to the center plane 26 (see FIG. 1b) so that the projections 74, 76, 98, 100 protrude into two guide grooves 36, 38 (on both sides of the running rail 16, see FIG. 2a).

From FIGS. 1a to 2b, it can be seen that the projection(s) 74, 76, 98, 100 is/are preferably formed to be vertically lower than the upper side of the running rail 16, in particular lower than the upper side 42. The projection(s) 74, 76, 98, 100 thus preferably protrude below the upper edge of the running rail 16, in particular the upper side 42.

When viewing all the figures of the drawing in combination, the invention thus relates in summary to a door 10 with a barrier-free sill 14. The sill 14 preferably comprises recesses 40 on its upper side 42, the width B of said recesses being less than 50 mm and/or the depth T of said recesses being less than 3 mm. A leaf 12 can penetrate the upper side 42 in a leaf recess 32. The leaf 12 may fall below the vertically uppermost dimension of a running rail 16. Using at least one projection 74, 76, 98, 100 of a carriage 18 that extends into a guide groove 36, 38, it is possible to reliably seal or transversely support the leaf 12 in the event of wind pressure or a break-in attempt. The projection 74, 76, 98, 100 preferably extends further down than a running roller 68a, b of the carriage 18. The invention enables the design of a particularly stable and yet barrier-free door 10.

### LIST OF REFERENCE SIGNS

10 Door
12 Leaf
14 Sill
16 Running rail
18 Carriage
20 Fastening part
22 Roller part
24 Direction of extension of the running rail 16
26 Virtual vertical center plane through the running rail 16
28 Main plane of the leaf
30 Seal
31 Sealing strip
32 Leaf recess
34 Extension part
36 First guide groove
38 Second guide groove
40 Upper-side recesses of the sill 14
42 Upper side of the sill 14
44a-d Jump lines
46 Virtual plane of the jump lines 44a-d
48a,b Attachment part of the sill 14
50 Rail with running rail 16
52 Axis for pivoting the rail 50
54 Driving bar unit
56 Driving bar
58 Control pin
60 Longitudinal axis of the driving bar 56
62 Guide cam of the fastening part 20
64 Control cam of the roller part 22
66 Guide of the roller part 22
68a,b Running roller
70 Attachment
72 Fastening pin for the attachment 70
73 Roller part body
74 First projection
76 Second projection
78 Bearing on the first projection 74
80 Bearing on the second projection 76
82 Shell of the bearing 78
84 Shell of the bearing 80
86 Cap of the bearing 78
88 Cap of the bearing 80
90 Rivet of the bearing 78
92 Rivet of the bearing 80
94 Bushing of the bearing 78
96 Bushing of the bearing 80
98 Further projection
100 Further projection
B Width of the recesses 40
T Depth of the recesses 40

What is claimed is:

1. A door, wherein the door comprises:
a) a sill with a running rail;
b) a leaf configured to be displaced in parallel with the running rail;
c) a carriage via which the leaf is supported downward on the running rail;
wherein the carriage comprises a roller part with a running roller rolling on the running rail and a control cam running at least in sections at an angle to the main plane of the leaf, wherein the roller part is designed to be movable transversely to the main plane of the leaf;
and the leaf comprises a driving bar with a control pin which is arranged or formed on the driving bar and protrudes into the control cam wherein a movement of the driving bar in the direction of its longitudinal axis causes a movement of the roller part transverse to the main plane of the leaf in order to move the leaf transversely to the running rail;
wherein the sill comprises recesses on the upper side whose respective maximum horizontal width perpendicular to the running rail does not exceed 50 mm and/or whose respective maximum vertical depth does not exceed 3 mm.

2. The door according to claim 1, wherein the leaf at its underside dips in sections into a leaf recess of the sill wherein the leaf extends in sections below the upper side of the sill.

3. The door according to claim 2, wherein the leaf recess and/or the leaf comprises a sealing strip which extends in parallel with the running rail and via which the leaf in its closed position in the leaf recess bears against the sill in a sealing manner.

4. The door according to claim 1, wherein the leaf extends at its underside in sections below the uppermost point of the running rail.

5. The door according to claim 1, wherein the running rail is formed on a pivotable rail.

6. The door according to claim 1, wherein the leaf comprises an extension part extending down.

7. The door according to claim 1, wherein the recesses are delimited by jump lines extending in parallel with the running rail, wherein the jump lines lie in a virtual plane.

8. The door according to claim 1, wherein the sill comprises a first guide groove extending in parallel with the running rail, wherein a first projection of the carriage extends down beyond the running roller into the first guide groove wherein the carriage can be supported via the first projection on the side wall of the first guide groove and/or the side of the running rail when the leaf is loaded transversely to the extension of the running rail.

9. The door according to claim 8, wherein the first projection comprises a bearing that can roll on the side wall of the first guide groove and/or the side of the running rail when the leaf is loaded transversely to the extension of the running rail.

10. The door according to claim 8, wherein the roller part comprises an attachment with the first projection, which is fastened to a roller part body.

11. The door according to claim 8, wherein the roller part comprises a second projection which extends down beyond the running roller into the first guide groove wherein the carriage can be supported via the second projection on the side wall of the first guide groove and/or the side of the running rail when the leaf is loaded transversely to the extension of the running rail.

12. The door according to claim 11, wherein the first projection and the second projection are formed identically.

13. The door according to claim 8, wherein the sill comprises a second guide groove extending in parallel with the running rail, wherein the running rail is arranged or formed between the first guide groove and the second guide groove when viewed horizontally, and wherein a further projection of the carriage extends down beyond the running roller into the second guide groove wherein the carriage can be supported via the further projection on the side wall of the second guide groove and/or the side of the running rail when the leaf is loaded transversely to the extension of the running rail.

14. The door according to claim 13, wherein the first projection and the further projection are formed identically.

15. The door according to claim 14, wherein the sill comprises a first guide groove extending in parallel with the running rail, wherein a first projection of the carriage extends down beyond the running roller into the first guide groove wherein the carriage can be supported via the first projection on the side wall of the first guide groove and/or the side of the running rail when the leaf is loaded transversely to the extension of the running rail, wherein the roller part comprises an attachment with the first projection, which is fastened to a roller part body, and wherein the attachment is formed mirror-symmetrically to a virtual plane extending vertically and in the longitudinal direction of the running rail in the middle of the running rail.
